(19) United States
(12) Patent Application Publication
(10) Pub. No.: US 2025/0226786 A1
(43) Pub. Date: Jul. 10, 2025

(54) SOLAR PANEL MODULE CLAMP

(71) Applicant: Gamechange Solar Corp., Norwalk, CT (US)

(72) Inventors: Andrew Barron Worden, Greenwich, CT (US); Jacob Grant, Springfield, MA (US); Zachary Cutting, Westminster, MA (US)

(73) Assignee: Gamechange Solar Corp., Norwalk, CT (US)

(21) Appl. No.: 18/791,775

(22) Filed: Aug. 1, 2024

Related U.S. Application Data
(60) Provisional application No. 63/530,606, filed on Aug. 3, 2023.

(51) Int. Cl. H02S 20/30; F16B 2/24; F16B 5/06

(52) U.S. Cl. CPC H02S 20/30; F16B 2/245; F16B 5/0685

(57) ABSTRACT

A photovoltaic module clamp that secures a photovoltaic module to a structural support surface includes a web that separates a first sidewall and a second sidewall at a distal end of the clamp, where the first and second sidewalls are substantially opposing and spaced apart to form a cavity. The web includes a plurality of segments including a plurality of radiused segments. The first sidewall includes a through hole that receives a projection extending from the structural support surface. The second sidewall includes a slot extending from a proximate end of the second sidewall towards the distal end of the clamp, and the proximate end of the second sidewall flares outwardly from the cavity. The first sidewall has a first sidewall length extending along the first sidewall between the proximate and distal ends that is greater than a second sidewall length of the second sidewall extending along the second sidewall between the proximate and distal ends. A projection extends obliquely from second sidewall into the cavity and the through hole.

### CROSS REFERENCE TO RELATED APPLICATIONS

This application claims the benefit of U.S. Provisional Patent Application Ser. No. 63/530,606 filed Aug. 3, 2023, which is hereby incorporated by reference.

### BACKGROUND OF THE INVENTION

### 1. Technical Field

This disclosure relates generally to a solar panel installation and, more particularly, to apparatuses and assemblies for use in a solar panel installation.

### 2. Background Information

To fasten the solar panels to a mount (e.g., a tracker or fixed tilt), various systems, mounting brackets, clamps and other fasteners exist. In a utility scale solar power plant not only must the system for mounting photovoltaic panels be secure and rugged, but the system must also be relatively easy and quick to install.

There is a need for an improved assembly for mounting a photovoltaic module.

### SUMMARY OF THE DISCLOSURE

According to an aspect of the present disclosure, a photovoltaic module clamp that secures a photovoltaic module to a structural support surface includes a web that separates a first sidewall and a second sidewall at a distal end of the clamp, where the first and second sidewalls are substantially opposing and spaced apart to form a cavity. The web includes a plurality of segments comprising a plurality of radiused segments and the first sidewall includes a through hole that receives a projection extending from the structural support surface. The second sidewall includes a slot extending from a proximate end of the second sidewall towards the distal end of the clamp, and the proximate end of the second sidewall flares outwardly from the cavity. The first sidewall has a first sidewall length extending along the first sidewall between the proximate and distal ends that is greater than a second sidewall length of the second sidewall extending along the second sidewall between the proximate and distal ends. A projection extends obliquely from the second sidewall into the cavity and the through hole.

The web, the first and second sidewalls and the projection may form a unitary single piece structure.

The unitary single piece structure may be metallic.

The web may be a bulbous shape.

A projection longitudinal center line CL of the clamp projection may extend between the distal and proximate ends and may be parallelly aligned with a hole longitudinal center line of the hole in the first sidewall.

The hole may be rectangularly shaped.

The proximate ends of the second sidewall forming the slot may be one of chamfered or bullnosed.

According to another aspect of the disclosure, a photovoltaic module clamp includes a web extending between a first sidewall and a second sidewall at a distal end of the clamp, where the first and second sidewalls are substantially opposing and spaced apart to form a cavity. The web may include a plurality of segments including a plurality of radiused segments. The first sidewall includes a through hole and the second sidewall includes a slot extending from a proximate end of the second sidewall towards the distal end of the clamp. The proximate end of the second sidewall flares outwardly away from the cavity. The first sidewall has a first sidewall length extending along the first sidewall between the proximate and distal ends that is greater than a second sidewall length of the second sidewall extending along the second sidewall between the proximate and distal ends. A projection extends obliquely from the second sidewall into the cavity and the through hole.

According to yet another aspect of the disclosure, a solar panel mounting subassembly includes a tube and a purlin attached to the tube. The purlin includes a purlin sidewall with a projection extending outwardly from the sidewall. A photovoltaic module includes a frame that includes an exterior mounting hole. A clamp secures the photovoltaic module to the purlin. The clamp includes a web extending between a first sidewall and a second sidewall at a distal end of the clamp, where the first and second sidewalls are substantially opposing and spaced apart to form a cavity. The web includes a plurality of segments including a plurality of radiused segments.

The first sidewall includes a through hole and the second sidewall includes a slot extending from a proximate end of the second sidewall towards the distal end of the clamp. The proximate end of the second sidewall flares outwardly away from the cavity. The first sidewall has a first sidewall length extending along the first sidewall between the proximate and distal ends that is greater than a second sidewall length of the second sidewall extending along the second sidewall between the proximate and distal ends. A clamp projection extends obliquely from the second sidewall into the cavity, the through hole and the exterior mourning hole, where a section of the frame and the purlin sidewall are positioned in the cavity between the first and second sidewalls.

The proximate end of the second sidewall may include a proximate end segment that flares outwardly from the cavity.

The tube may include a rotatable torque tube.

The foregoing features and the operation of the invention will become more apparent in light of the following description and the accompanying drawings.

### BRIEF DESCRIPTION OF THE DRAWINGS

FIG. 1 is a first perspective view of a photovoltaic module clamp;

FIG. 2 is a second perspective view of the clamp of FIG. 1;

FIG. 3 is a side view of the clamp of FIGS. 1 and 2;

FIG. 4 is a top view of the clamp of FIGS. 1-3;

FIG. 5 is a bottom view of the clamp of FIGS. 1-4;

FIG. 6 is a flat view of the clamp of FIGS. 1-5;

FIG. 7 is a perspective cross sectional view of a solar panel mounting subassembly that includes a purlin that mounts to a torque tube, and the clamp of FIGS. 1-6 attaching a photovoltaic module frame to the purlin; and

FIG. 8 is a cross sectional view of a portion of the solar panel mounting subassembly of FIG. 7 that includes a purlin that mounts to a torque tube, and the clamp of FIGS. 1-6 attaching a photovoltaic module frame to the purlin.

### DETAILED DESCRIPTION

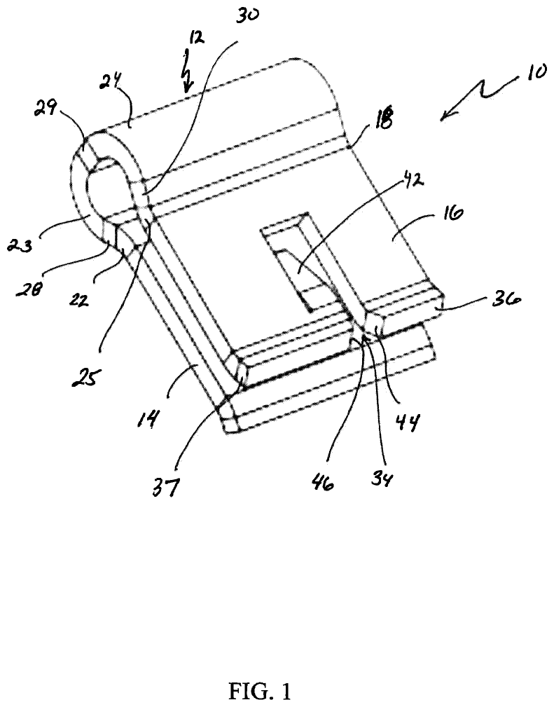

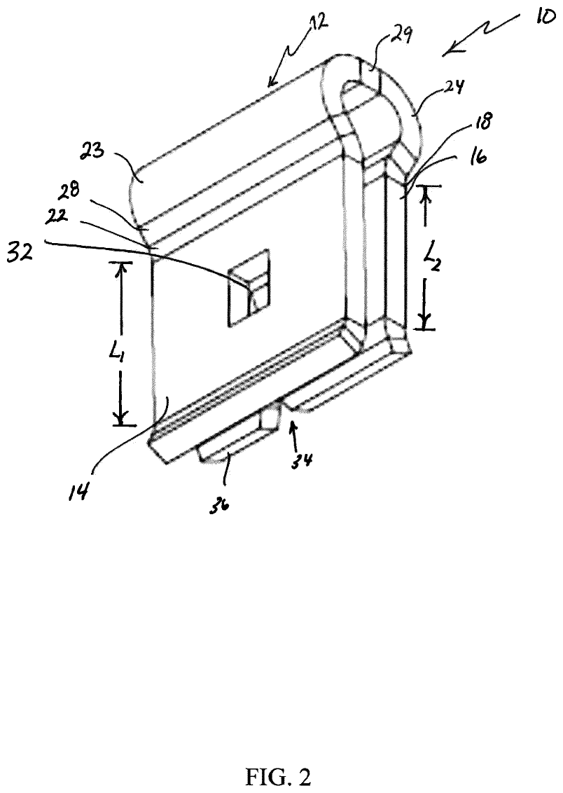

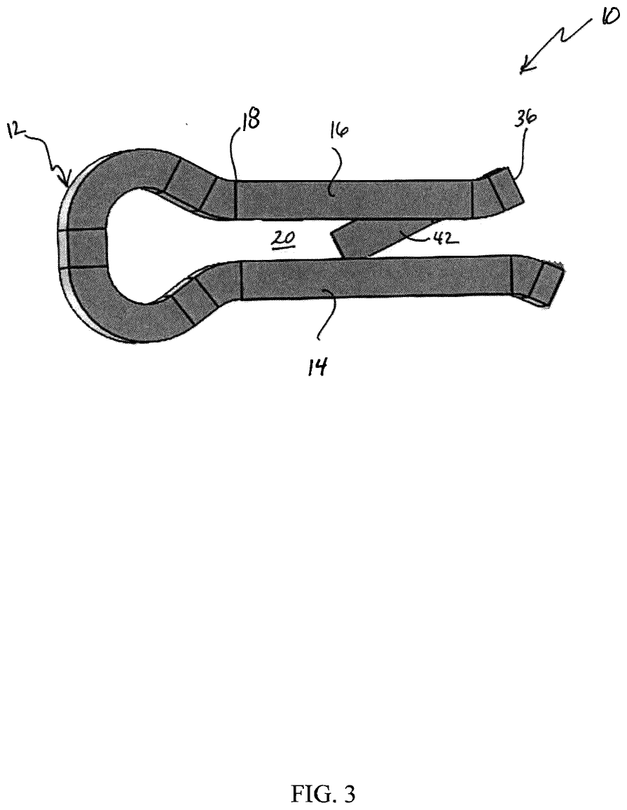

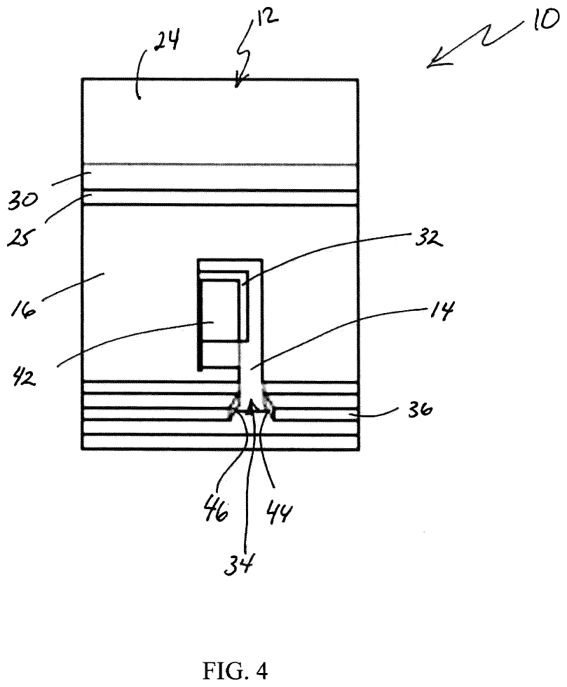

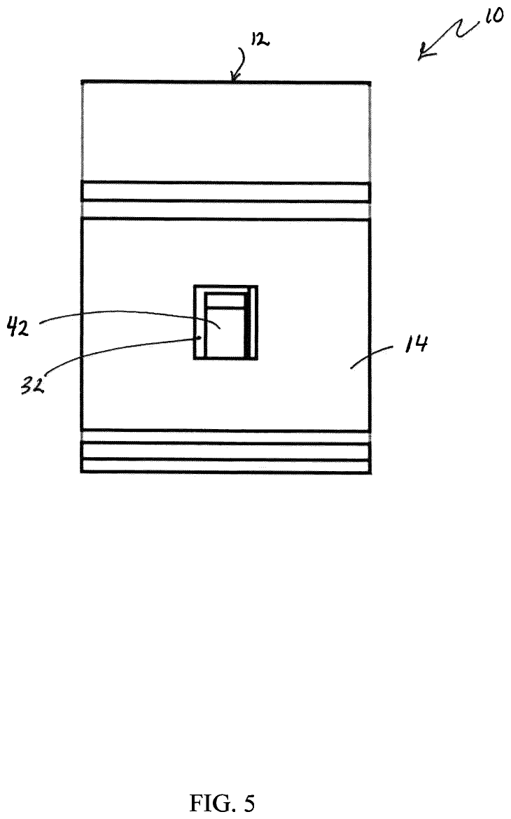

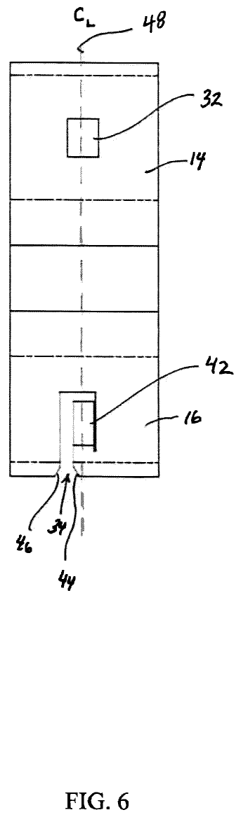

FIG. 1 is a first perspective view of a photovoltaic module clamp 10. FIG. 2 is a second perspective view of the clamp of FIG. 1. FIG. 3 is a side view of the clamp of FIGS. 1 and 2. FIG. 4 is a top view of the clamp of FIGS. 1-3. FIG. 5 is a bottom view of the clamp of FIGS. 1-4. FIG. 6 is a flat view of the clamp of FIGS. 1-5. Referring to FIGS. 1-6, the clamp 10 secures a photovoltaic (PV) module/solar panel to a structural support surface, such as a purlin, which is attached to a tube (e.g., a torque tube) of a solar racking system. The system may be a tracker or a fixed tilt system. The clamp 10 includes a web 12 that separates a first sidewall 14 and a second sidewall 16 at a distal end 18. In an exemplary embodiment, the first and second sidewalls 14, 16 are substantially opposing and spaced apart to form a cavity 20. The web 12 includes a plurality of segments, for example including a plurality of radiused segments 22-25 and a plurality of non-radiused (e.g., linear) segments 28-30. The web may be substantially bulbous. It is contemplated that the web may take on various shapes which ensure during loading the clip does not open up.

The first sidewall 14 includes a through hole 32 that receives a projection extending from the structural support surface (not shown in FIGS. 1-4). In an exemplary embodiment the hole 32 may be substantially rectangular. However, it is contemplated that the hole 32 may be one of various complementary shapes dependent on the shape of the projection extending from the structural support surface (not shown in FIGS. 1-4). The projection extending from the structural support shall be discussed below.

The second sidewall 16 includes a slot 34 extending from a proximate end 36 of the second sidewall towards the distal end 18. The proximate end of the second sidewall includes a proximate end segment 37 that flares outwardly from the cavity 20.

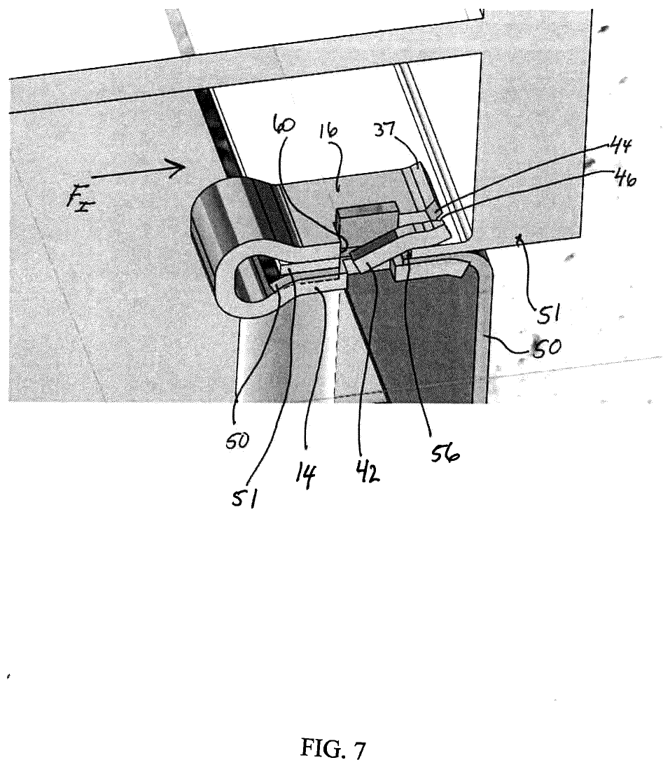

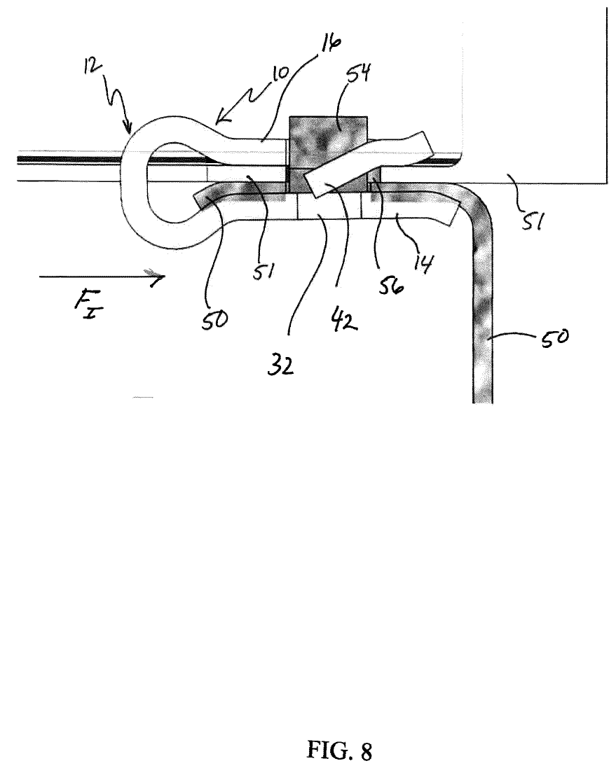

The first sidewall 14 has a length Li extending along the first sidewall between its distal and proximate ends 18, 36, and is greater than a length L2 of the second sidewall 16 extending along the second sidewall between the proximate and distal ends 18, 36. In an exemplary embodiment the first sidewall 14 is adjacent to the purlin and the second sidewall 16 is adjacent to the photovoltaic module frame. This shall be discussed below with respect to FIGS. 7 and 8.

A clamp projection 42 extends obliquely from the second sidewall 14 into the cavity 20 and the through hole 32.

The web 12, the first and second sidewalls 14, 16 and the clamp projection 42 may form a unitary (e.g., single-piece) structure, as shown in FIG. 6, which illustrates a flat view of the clamp 10. In an exemplary embodiment the clamp 10 is metallic. However, it is contemplated that the clamp 10 may also be semi-metallic or non-metallic.

In an exemplary embodiment, proximate end walls 44, 46 of the second sidewall 16 forming the slot 34 are one of chamfered or bullnosed to increase the opening of the slot at the proximate end of the second sidewall 16.

A projection longitudinal center line CL 48 (FIG. 6) of the clamp projection 42 extends between the distal and proximate ends 18, 36, and may be parallelly aligned with a hole longitudinal center line of the hole 32 in the first sidewall 14, extending between the distal and proximate ends 18, 36.

FIG. 7 is a perspective cross sectional view of a solar panel mounting subassembly that includes a purlin 50 which mounts to a tube (not shown), and the clamp 12 of FIGS. 1-6 attaching a photovoltaic module frame 51 to the purlin 50. FIG. 8 is a cross sectional view of a portion of the solar panel mounting subassembly that includes the purlin 50 and the clamp 10 of FIGS. 1-6 attaching the photovoltaic module frame 51 to the purlin 50. The solar tracker subassembly may be, for example, part of a single-axis solar tracker, a dual-axis tracker or a fixed tilt system. An example of a popular single-axis solar tracker that includes a torque tube and purlins is disclosed in U.S. Pat. No. 10,605,489 entitled “Apparatuses and Assemblies for Solar Panel Installation”, assigned to the assignee of the present application. Referring to FIGS. 7-8, the purlin 50 includes a finger 54 that extends from a support surface 56 of the purlin.

Referring to FIGS. 1-8, to secure a photovoltaic module to a structural support surface (e.g., a purlin), starting with the photovoltaic module positioned on the purlin 50 with the finger 54 extending through a hole 56 in the photovoltaic module frame 21 as shown in FIGS. 7 and 8, the clamp 12 is pushed along the longitudinal center line CL 48 of the hole 32 in the first sidewall 14 to apply an installation force FI. This causes the clamp 12 to slide with the stationary purlin and the stationary module frame in the cavity. With the installation force FI applied, the clamp 10 continues to slide with the purlin finger 54 moving along the length of the slot 34 until the purlin finger 54 abuts a back surface 60 of the second sidewall 16, and at this point the resilient flexible projection 42 snaps into the hole 32 in the first sidewall 14. With the resilient projection 42 located in the hole 32, the photovoltaic module 51 is firmly positioned on the purlin 50.

It is contemplated that at least one of the clamp projection 42 and the finger 54 may include punched teeth so the clamp bites into the finger, or visa versa, for grounding.

To remove the clamp 12, a sufficient force FR is applied in the opposite direction of the installation force Fr and the resilient flexible projection 42 is pushed upward towards the second sidewall 16 so the resilient flexible projection 42 no longer strikes (i.e., is blocked by) the hole in the photovoltaic module frame.

The clamp allows an installer to quickly, safely and easily secure a PV module to a support structure (e.g., a purlin). The clamp can be installed by hand, without the need of a tool, for ease of installation. However, it is of course contemplated that a tool may be used.

Although the subject matter has been described in language specific to structural features or methodological acts, it is to be understood that the subject matter defined in the appended claims is not necessarily limited to the specific features and acts described above. Rather, the specific features and acts described above are disclosed as example forms of implementing at least one of the claims.

Various operations of embodiments are provided herein. The order in which some or all of the operations described should not be construed to imply that these operations are necessarily order dependent. Alternatively ordering will be appreciated having the benefit of this description. Further it will be understood that not all operations are necessarily present in each embodiment provided herein. Also it will be understood that not all operations are necessary in some embodiments.

Many modifications may be made to the current invention without departing from the scope or spirit of the claimed subject matter. Unless specified otherwise, “first,” “second,” or the like are not intended to imply a temporal aspect, a spatial aspect, an ordering etc. Rather such terms are merely used as identifiers names etc. for features, elements, items etc. for features, elements, items, etc. For example, a first location and a second location correspond to location A and location B or two different or two identical locations or the same location.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alternations and modifications will occur to others skilled in the art based upon reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe the components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one or several implementations, such feature may be combined with one or more other features of the other implementations as may be desired and advantageous for any given or particular application.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A photovoltaic module clamp that secures a photovoltaic module to a structural support surface, the clamp comprising:
a web that separates a first sidewall and a second sidewall at a distal end of the clamp, where the first and second sidewalls are substantially opposing and spaced apart to form a cavity;
where the web includes a plurality of segments comprising a plurality of radiused segments;
where the first sidewall includes a through hole that receives a projection extending from the structural support surface;
where the second sidewall includes a slot extending from a proximate end of the second sidewall towards the distal end of the clamp, and the proximate end of the second sidewall flares outwardly from the cavity;
where the first sidewall has a first sidewall length extending along the first sidewall between the proximate and distal ends that is greater than a second sidewall length of the second sidewall extending along the second sidewall between the proximate and distal ends; and
a projection extending obliquely from the second sidewall into the cavity and the through hole.

2. The photovoltaic module clamp of claim 1, where the web, the first and second sidewalls and the projection form a unitary single piece structure.

3. The photovoltaic module clamp of claim 2, where the unitary single piece structure is metallic.

4. The photovoltaic module clamp of claim 3, where the web is a bulbous shape.

5. The photovoltaic module clamp of claim 3, where a projection longitudinal center line CL of the clamp projection extends between the distal and proximate ends and is parallelly aligned with a hole longitudinal center line of the hole in the first sidewall.

6. The photovoltaic modular clamp of claim 5, where the hole is rectangularly shaped.

7. The photovoltaic modular clamp of claim 6, where the proximate ends of the second sidewall forming the slot are one of chamfered or bullnosed.

8. A photovoltaic module clamp, comprising:
a web extending between a first sidewall and a second sidewall at a distal end of the clamp, where the first and second sidewalls are substantially opposing and spaced apart to form a cavity;
where the web includes a plurality of segments comprising a plurality of radiused segments;
where the first sidewall includes a through hole;
where the second sidewall includes a slot extending from a proximate end of the second sidewall towards the distal end of the clamp, and the proximate end of the second sidewall flares outwardly away from the cavity;
where the first sidewall has a first sidewall length extending along the first sidewall between the proximate and distal ends that is greater than a second sidewall length of the second sidewall extending along the second sidewall between the proximate and distal ends; and
a projection extending obliquely from the second sidewall into the cavity and the through hole.

9. A solar panel mounting subassembly, comprising:
a tube;
a purlin attached to the tube, the purlin comprising a purlin sidewall with a projection extending outwardly from the sidewall;
a photovoltaic module comprising a frame that includes an exterior mounting hole;
a clamp to secure the photovoltaic module to the purlin, the clamp comprising
a web extending between a first sidewall and a second sidewall at a distal end of the clamp, where the first and second sidewalls are substantially opposing and spaced apart to form a cavity;
where the web includes a plurality of segments comprising a plurality of radiused segments;
where the first sidewall includes a through hole;
where the second sidewall includes a slot extending from a proximate end of the second sidewall towards the distal end of the clamp, and the proximate end of the second sidewall flares outwardly away from the cavity;
where the first sidewall has a first sidewall length extending along the first sidewall between the proximate and distal ends that is greater than a second sidewall length of the second sidewall extending along the second sidewall between the proximate and distal ends; and
a clamp projection extending obliquely from the second sidewall into the cavity, the through hole and the exterior mourning hole, where a section of the frame and the purlin sidewall are positioned in the cavity between the first and second sidewalls.

10. The solar panel mounting subassembly of claim 9, where the proximate end of the second sidewall includes a proximate end segment that flares outwardly from the cavity.

11. The solar panel mounting subassembly of claim 9, where the tube comprise a rotatable torque tube.
